(19) United States
(12) Patent Application Publication
(10) Pub. No.: US 2023/0418364 A1
(43) Pub. Date: Dec. 28, 2023

(54) Methods and Systems for Selecting a Virtual Element in a Virtual or Augmented Reality Environment Generated by an Electronic Device

(71) Applicant: Motorola Mobility LLC, Chicago, IL (US)

(72) Inventors: Ranjeet Gupta, Aurora, IL (US); Balachandar Swami, Buffalo Grove, IL (US)

(21) Appl. No.: 17/849,349

(22) Filed: Jun. 24, 2022

(51) Int. Cl. G06F 3/01; G06F 3/04812; G06T 19/00; G02B 27/01

(52) U.S. Cl. CPC G06F 3/011; G06F 3/04812; G02B 27/017; G06T 19/003; G06T 19/006

(57) ABSTRACT

A method of selecting a virtual element in a virtual reality or augmented reality (VR/AR) environment generated by a VR/AR device includes detecting, with one or more processors, a cursor interacting with the virtual element. One or more sensors determine whether either the VR/AR device is stationary for at least a predefined duration while the cursor interacts with the virtual element or whether a variation of a predefined number of movement measurement samples is within a predefined variation threshold while the cursor interacts with the virtual element. When the condition is met, one or more processors select and/or actuate the virtual element.

### BACKGROUND

### Technical Field

This disclosure relates generally to electronic devices, and more particularly to electronic devices capable of generating virtual reality or augmented reality environments for a user.

### Background Art

As user interface technology has evolved, the user experience provided by certain electronic devices has become richer and more immersive. Rather than simply providing a display that presents a two-dimensional image to a user, immersive head mounted displays have been developed to provide alternative reality experiences to a user. These alternative reality experiences occur when electronically rendered images are delivered to a user's eyes in such a way that they are perceived as real objects.

Conventional head mounted displays can provide, for example, a “virtual” reality experience to a user for gaming, simulation training, or other purposes. In virtual reality systems, images are presented to a user's eyes solely from an electronic device without the addition of light or images from the physical environment. Other conventional head mounted displays can provide a different experience, namely, an “augmented” reality experience to a user. In augmented reality systems, electronically generated images are presented to a user as an augmentation to light or images from the physical environment.

While such conventional head mounted displays can perform well for their given technologies, navigation through the environments these devices provide can be tricky. Virtual elements such as icons and user actuation targets can exist close to each other in the virtual environment, making selection of a particular virtual element difficult. It would be advantageous to have an improved user interface allowing for selection of a virtual element in a virtual reality or augmented reality (VR/AR) environment easier and more intuitive.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory virtual reality device in accordance with one or more embodiments of the disclosure.

FIG. 2 illustrates one explanatory augmented reality device in accordance with one or more embodiments of the disclosure.

FIG. 3 illustrates one explanatory augmented reality device in use in accordance with one or more embodiments of the disclosure.

FIG. 4 illustrates one explanatory virtual reality system in accordance with one or more embodiments of the disclosure.

FIG. 5 illustrates one or more method steps in accordance with one or more embodiments of the disclosure.

FIG. 6 illustrates a prior art virtual element selection mechanism.

FIG. 7 illustrates another prior art virtual element selection mechanism.

FIG. 8 illustrates still another prior art virtual element selection mechanism.

FIG. 9 illustrates a portion of a prior art virtual element selection method.

FIG. 10 illustrates another portion of the prior art virtual element selection method of FIG. 9.

FIG. 11 illustrates one explanatory method in accordance with one or more embodiments of the disclosure.

FIG. 12 illustrates one or more method steps in accordance with one or more embodiments of the disclosure.

FIG. 13 illustrates one explanatory virtual reality system in accordance with one or more embodiments of the disclosure.

FIG. 14 illustrates another explanatory method in accordance with one or more embodiments of the disclosure.

FIG. 15 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related selecting a virtual element when a VR/AR device is stationary for at least a predefined duration while a cursor interacts with the virtual element. Any process descriptions or blocks in flow charts should be understood as representing modules, segments, or portions of code that include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of presenting a VR/AR environment that includes a cursor and one or more virtual elements, determining whether a VR/AR headset is moving or stationary in three-dimensional space when the cursor interacts with a particular virtual element, and selecting and actuating the virtual element in response to one or more motion detectors determining the VR/AR headset is stationary in the three-dimensional space while the cursor is interacting with the virtual element. The non-processor circuits may include, but are not limited to, light emitting display devices, a radio receiver, a radio transmitter, signal drivers, clock circuits, power source circuits, and user input devices. As such, these functions may be interpreted as steps of a method to perform the selection and actuation of a virtual element in a VR/AR environment when a VR/AR headset is sufficiently stable, such as when a variation of a predefined number of movement measurement samples is less than a predefined variation threshold.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially”, “essentially”, “approximately”, “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, a principal challenge associated with VR/AR devices concerns how to access and navigate through presentations of virtual elements available to the user in either the virtual reality or augmented reality space. Illustrating by example, a user may start an augmented reality experience at a home screen that is presented during an onboarding process. This home screen may present a variety of virtual elements that represent various applications, widgets, buttons, controls, and other user actuation targets the user may select to launch applications, control hardware, and/or explore other portions of the VR/AR environment. In many instances, the number of virtual elements will be many, and the presentation will be a closely packed tiled arrangement where virtual elements are placed relatively close together. This makes selection of a particular virtual element a challenging process.

Some VR/AR devices incorporate hand-held user input devices that a user manipulates to select a particular virtual element. The problem with these hand-held user interfaces is that they frequently require a secondary device, such as a “lighthouse” or other tracking sensor to track and correlate movement of each hand-held device.

To eliminate this need for additional hardware, more modern VR/AR devices use one of a number of different techniques for virtual element selection. Examples of these different techniques include voice control, gesture control, “gaze and dwell,” and via the actuation of buttons or other controls on the exterior of the VR/AR device. Voice control requires complex audio processing, while gesture control requires complex imaging devices and corresponding processing systems to detect movement of a user's hand in three-dimensional space. The use of buttons or controls on the exterior of the VR/AR device is cumbersome and challenging, especially when the VR/AR device is operating as an augmented reality device. For this reason, the primary prior art method of selecting a virtual element in an VR/AR environment is the gaze and dwell method.

The “gaze and dwell” method is a technique that requires to distinct and separate control operations to successfully function. In the “gaze” portion, a cursor moves within the VR/AR environment and is correlated with motion of the user's head. Accordingly, the user moves the cursor in the VR/AR environment by moving their head in three-dimensional space (presuming the VR/AR device is a head-worn device).

In the “dwell” portion of the method, the cursor is first aligned with a virtual element. From here, a “door” then appears alongside the virtual element. The user must then move the cursor to the door and cause the cursor to hover or “dwell” at the door. This causes the door to close (or other similar animation to occur), finally causing actuation of the virtual element once the door animation completes. Accordingly, the gaze and dwell method is a timer-based process requiring a navigation step to select a virtual element to cause the door to appear and another waiting process while the timer countdown step occurs as the animation of the door proceeds. In effect, the result of these multiple processes is that once the cursor is made to hover over a virtual element, a timer is initiated. When the timer expires, the virtual element initially selected is actuated.

The problem with gaze and dwell is that false selection of virtual elements frequently occurs. Since virtual elements are typically packed quite closely together in a VR/AR environment, it is frequently the case when a user is looking at a particular virtual element (perhaps to read an identifier or otherwise figure out what the virtual element does) an accidental selection will occur causing a door to appear. Moreover, when a virtual element represents a bundle of sub-virtual elements that open when the virtual element is initially selected, this accidental selection can further clutter the VR/AR environment, thereby making selection of a desired virtual element even more difficult.

To compound matters, gaze and dwell is prone to misuse. In the development cycle of virtual reality or augmented reality applications, new software code is frequently added. When not properly vetted, this new code can include security vulnerabilities that can be exploited by rogue or spy software code that may perform a malicious task that is harmful the VR/AR device user.

Embodiments of the disclosure provide a new and improved method of selecting a virtual element in a VR/AR environment that provides solutions to these problems by both eliminating the time-based selection component of the dwell portion of the gaze and dwell method and by reducing the number of overall steps required to actuate a virtual element. In particular, rather than using a timer countdown, embodiments of the disclosure sample one or more motion detectors incorporated in the VR/AR device to determine whether the VR/AR device is moving or stationary in three-dimensional space.

In one or more embodiments motion, as detected by the one or more motion detectors, is used to move the cursor in the VR/AR environment. Embodiments of the disclosure then leverage these motion detectors to determine when the VR/AR device is stationary when the cursor interacts with a particular virtual element, thereby allowing for the elimination of any timer countdown requirement in a virtual element selection process.

In one or more embodiments, when a cursor interacts with a virtual element, such as when a portion of the cursor hovers within a perimeter defined by the virtual element, one or more processors of the VR/AR device monitor and/or sample data from the one or more motion detectors. When the user's head, and thus the VR/AR device, is determined to be stable, the one or more processors sample the data from the one or more motion detectors to determine whether the VR/AR device is stationary for at least a predefined duration in three-dimensional space while the cursor interacts with the virtual element. In one or more embodiments, when this occurs, the one or more processors select and/or actuate the virtual element with which the cursor is interacting. If the virtual element happens to be a virtual element with multiple sub-virtual elements “underneath” it, another set of sub-virtual elements can be presented when the primary virtual element is selected and actuated.

Advantageously, embodiments of the disclosure eliminate the false or accidental selection of virtual element in an VR/AR environment that frequently occurs when the gaze and dwell method is used. Illustrating by example, using the prior art system of gaze and dwell, a user has a limited amount of time defined by the countdown timer of the door within which they can interact with a virtual element before it is actuated. If they are trying to read a description or other content associated with the virtual element, they'd better read fast because the timer is ticking! By contrast, using embodiments of the disclosure where actuation is based upon VR/AR device stability, a user can interact with a virtual element for an indefinite amount of time without actuation, instead actuating the virtual element only when the user is certain that the desired virtual element is the one with which the cursor is interacting. Other advantages will be obvious to those of ordinary skill in the art having the benefit of this disclosure.

In one or more embodiments, a method of selecting a virtual element in a VR/AR environment generated by a VR/AR device includes detecting, with one or more processors, a cursor interacting with the virtual element. In one or more embodiments, the method includes determining, with one or more sensors, whether the VR/AR device is stationary for at least a predefined duration while the cursor interacts with the virtual element. In one or more embodiments, the one or more processors select the virtual element when the VR/AR device is stationary for the predefined duration with the cursor interacting with the virtual element.

In another embodiment, a method of selecting a virtual element in a VR/AR environment generated by a VR/AR headset includes presenting, with a display device, the VR/AR environment. When one or more motion sensors detect movement of the VR/AR headset in three-dimensional space, one or more processors of the VR/AR headset move a cursor within the VR/AR environment as a function of the movement of the VR/AR headset in the three-dimensional space.

In this alternate method, rather than measuring time the determination of whether the VR/AR device is stationary includes obtaining at least a predefined number of movement measurement samples that have sufficiently consistent measurement readings to determine whether the stationary state has been maintained for a sufficient duration. In one or more embodiments, the one or more processors thus obtain from the one or more sensors in response to the cursor interacting with the virtual element a predefined number of movement measurement samples. The one or more processors actuate the virtual element in the VR/AR environment when a variation of the predefined number of movement measurement samples is less than a predefined variation threshold.

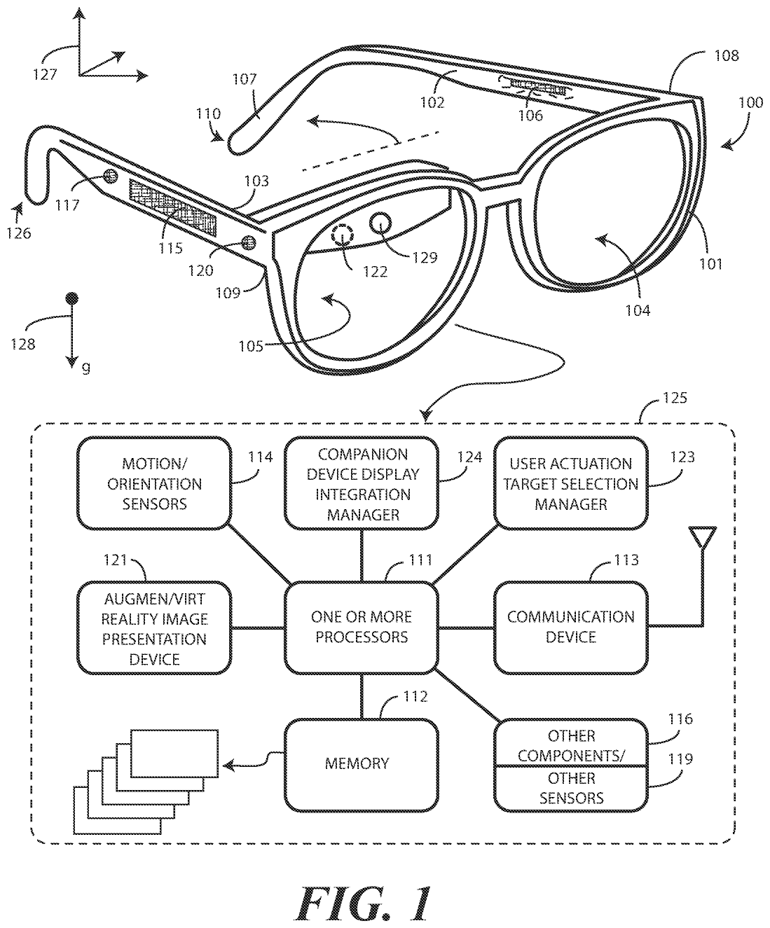

Turning now to FIG. 1, illustrated therein is one explanatory augmented reality device 100 configured in accordance with one or more embodiments of the disclosure. In the illustrative embodiment of FIG. 1, the augmented reality device 100 comprises augmented reality glasses. However, this is for explanatory purposes only, as the augmented reality device 100 could be configured in any number of other ways as well. Illustrating by example, the augmented reality device 100 could also be configured as any of sunglasses, goggles, masks, shields, or visors. Other forms of the augmented reality device 100 will be obvious to those of ordinary skill in the art having the benefit of this disclosure.

The augmented reality device 100 of FIG. 1 includes a frame 101 and one or more stems 102,103. Here, the one or more stems 102,103 comprise a first stem 102 and a second stem 103. One or more lenses 104,105 can be disposed within the frame 101. The lenses 104,105 can be prescription or non-prescription, and can be clear, tinted, or dark.

In one or more embodiments the stems 102,103 are pivotable from a first position where they are situated adjacent to, and parallel with, the frame 101, to a second, radially displaced open position shown in FIG. 1. However, in other embodiments the stems 102,103 may be fixed relative to the frame 101. In still other embodiments, such as might be the case if the augmented reality device 100 were configured as goggles, the stems 102,103 may be flexible or soft. For example, the stems of goggles are frequently elasticized fabric, which is soft, flexible, pliable, and stretchy. Other types of stems 102,103 will be obvious to those of ordinary skill in the art having the benefit of this disclosure.

In one or more embodiments the stems 102,103 attach to the frame 101 at a first end 108,109 and extend distally from the frame 101 to a second, distal end 110,126. In one embodiment, each stem 102,103 includes a temple portion 106 and an ear engagement portion 107. The temple portion 106 is the portion of the stem 102,103 passing from the frame 101 past the temple of a wearer, while the ear engagement portion 107 engages the wearer's ear to retain the augmented reality glasses to the wearer's head.

Since the augmented reality device 100 is configured as an electronic device, one or both of the frame 101 and the stems 102,103 can comprise one or more electrical components. These electrical components are shown illustratively in a schematic block diagram 125 in FIG. 1. It will be clear to those of ordinary skill in the art having the benefit of this disclosure that the electrical components and associated modules can be used in different combinations, with some components and modules included and others omitted. Components or modules can be included or excluded based upon need or application.

The electronic components can include one or more processors 111. The one or more processors 111 can be disposed in one or both of the stems 102,103 or the frame 101. The one or more processors 111 can be operable with a memory 112. The one or more processors 111, which may be any of one or more microprocessors, programmable logic, application specific integrated circuit device, or other similar device, are capable of executing program instructions and methods described herein. The program instructions and methods may be stored either on-board in the one or more processors 111, or in the memory 112, or in other computer readable media coupled to the one or more processors 111.

The one or more processors 111 can be configured to operate the various functions of the augmented reality device 100 and also to execute software or firmware applications and modules that can be stored in a computer readable medium, such as memory 112. The one or more processors 111 execute this software or firmware, in part, to provide device functionality. The memory 112 may include either or both static and dynamic memory components, may be used for storing both embedded code and user data.

In one or more embodiments, the augmented reality device 100 also includes an optional wireless communication device 113. Where included, the wireless communication device 113 is operable with the one or more processors 111 and is used to facilitate electronic communication with one or more electronic devices or servers or other communication devices across a network. Note that it is possible to combine the one or more processors 111, the memory 112, and the wireless communication device 113 into a single device, or alternatively into devices having fewer parts while retaining the functionality of the constituent parts.

The wireless communication device 113, which may be one of a receiver or transmitter, and may alternatively be a transceiver, operates in conjunction with the one or more processors 111 to electronically communicate through a communication network. For example, in one embodiment, the wireless communication device 113 can be configured to communicate through a traditional cellular network. Other examples of networks with which the communication circuit may communicate include proprietary networks and direct communication networks. In other embodiments, the wireless communication device 113 can communicate with near field or local area networks, infrared communication circuits, magnetic field modulation circuits, and Wi-Fi circuits. In one or more embodiments, the wireless communication device 113 can be configured to provide messaging functionality to deliver electronic messages to remote devices.

A battery or other energy storage device can be included to provide power for the various components of the augmented reality device 100. It will be obvious to those of ordinary skill in the art having the benefit of this disclosure that other energy storage devices can be used instead of the battery, including a micro fuel cell or an electrochemical capacitor. The battery can include a lithium-ion cell, lithium polymer cell, or a nickel metal hydride cell, such cells having sufficient energy capacity, wide operating temperature range, large number of charging cycles, and long useful life. The battery may also include overvoltage and overcurrent protection and charging circuitry. In one embodiment, the battery comprises a small, lithium polymer cell.

In one or more embodiments, a photovoltaic device 115, such as a solar cell, can be included to recharge the battery. In one embodiment, the photovoltaic device 115 can be disposed along the temple portion 106 of the stems 102,103. In this illustrative embodiment, two solar cells are disposed in the temple portion 106 of each stem 102,103, respectively.

Other components 116 can be optionally included in the augmented reality device 100 as well. For example, in one embodiment one or more microphones can be included as audio capture devices 117. These audio capture devices can be operable with the one or more processors 111 to receive voice input. Additionally, in one or more embodiments the audio capture devices 117 can capture ambient audio noise. Signals corresponding to captured audio can be transmitted to an electronic device in communication with the augmented reality device 100 or a server or cloud-computing device. The other component 116 can additionally include loudspeakers for delivering audio content to a user wearing the augmented reality device 100.

The other components 116 can also include a motion generation device for providing haptic notifications, vibration notifications, haptic feedback, or vibrational sensations to a user. For example, a piezoelectric transducer, rotational motor, or other electromechanical device can be configured to impart a force or vibration upon the temple portion 106 of the stems 102,103, or alternatively along the frame 101. The motion generation device can provide a thump, bump, vibration, or other physical sensation to the user. The one or more processors 111 can be configured to actuate the motion generation device to deliver a tactile or vibration output alone or in combination with other outputs such as audible outputs.

Similarly, in one or more embodiments the augmented reality device 100 can include a video capture device 129 such as an imager. The imager can be disposed within the frame 101 or stems 102,103. In one or more embodiments, the video capture device 129 can function as a to detect changes in optical intensity, color, light, or shadow in the near vicinity of the augmented reality device 100. As with the audio capture device 117, captured video information can be transmitted to an electronic device, a remote server, or cloud-computing device.

Other sensors 119 can be optionally included in the augmented reality device 100. One example of such a sensor is a global positioning system device for determining where the augmented reality device 100 is located. The global positioning system device can communicate with a constellation of earth orbiting satellites or a network of terrestrial base stations to determine an approximate location. While a global positioning system device is one example of a location determination module, it will be clear to those of ordinary skill in the art having the benefit of this disclosure that other location determination devices, such as electronic compasses or gyroscopes, could be used as well.

The other sensors 119 can also include an optional user interface. The user interface can be used, for example, to activate the circuit components or turn them OFF, control sensitivity of the other sensors 119, receive user input, and so forth. The user interface, where included, can be operable with the one or more processors 111 to deliver information to, and receive information from, a user. The user interface can include a rocker switch, slider pad, button, touch-sensitive surface, or other controls, and optionally a voice command interface. These various components can be integrated together.

In one or more embodiments, an audio output device 120, such as a loudspeaker or other transducer, can deliver audio output to a user. For example, piezoelectric transducers can be operably disposed within the stems 102,103. Actuation of the piezoelectric transducers can cause the stems 102,103 to vibrate, thereby emitting acoustic output. More traditional audio output devices 120, such as loudspeakers, can be used as well. The inclusion of both the audio output device 120 and the haptic device allows both audible and tactile feedback to be delivered.

In one or more embodiments, the augmented reality device 100 includes an augmented reality image presentation device 121 operable to deliver augmented reality imagery to a user. This augmented reality imagery is referred to as an augmented reality environment because it is this imagery that the user experiences when interacting with the augmented reality device 100. The augmented reality image presentation device 121 can be operable with a projector 122. In the illustrative embodiment of FIG. 1, the frame 101 supports the projector 122. In one or more embodiments the projector 122 is configured to deliver images to a holographic optical element when the augmented reality device 100 is operating in an augmented reality mode of operation.

In one embodiment, the projector 122 is a modulated light projector operable to project modulated light images along a surface or holographic optical element. In another embodiment, the projector 122 is a thin micro projector. In another embodiment, the projector 122 can comprise a laser projector display module. Other types of projectors will be obvious to those of ordinary skill in the art having the benefit of this disclosure.

In one or more embodiments, the projector 122 can include a lens and a spatial light modulator configured to manipulate light to produce images, including the virtual elements that appear in the augmented reality environment. The projector 122 can include a light source, such as a single white light emitting diode, multiple separate color light emitting diodes, or multiple separate color laser diodes that deliver visible light to the spatial light modulator through a color combiner. The augmented reality image presentation device 121 can drive the spatial light modulator to modulate the light to produce images. The spatial light modulator can be optically coupled (e.g., by free space propagation) to the lens and/or a beam steerer. Where used, a beam steerer serves to steer a spatially modulated light beam emanating from the spatial light modulator through the lens to create images.

One or more motion detectors 114 can be configured as an orientation detector that determines an orientation and/or movement of the augmented reality device 100 in three-dimensional space. Illustrating by example, the motion detectors 114 can include an accelerometer, gyroscopes, or other device to detect device orientation and/or motion of the augmented reality device 100 in three-dimensional space 127. Using an accelerometer as an example, an accelerometer can be included to detect motion of the augmented reality device 100. Additionally, the accelerometer can be used to sense some of the gestures of the user, such as those made by predefined movements of the head.

The motion detectors 114 can determine the spatial orientation and/or motion of an augmented reality device 100 in three-dimensional 127 space by, for example, detecting a gravitational direction 128 and acceleration due to applied forces. In addition to, or instead of, an accelerometer, an electronic compass can be included to detect the spatial orientation of the augmented reality device 100 relative to the earth's magnetic field. Similarly, one or more gyroscopes can be included to detect rotational orientation of the augmented reality device 100.

In one or more embodiments, the one or more motion detectors 114 comprise one or more inertial motion units. In one embodiment, the augmented reality device 100 includes only a single inertial motion unit that is situated, for example, in one of the stems 102,103 or, alternatively, the frame 101. In another embodiment, the augmented reality device 100 optionally includes a second inertial motion unit that is situated in the other of the stems 102,103, or alternatively in the frame 101. Additional inertial motion units can be included as necessitated by a particular application. For example, the augmented reality device 100 could include three inertial motion units, with one situated in stem 102, another situated in stem 103, and a third situated in the frame 101.

In one or more embodiments, each inertial motion unit comprises a combination of one or more accelerometers and one or more gyroscopes, and optionally one or more magnetometers, to determine the orientation, angular velocity, and/or specific force of the augmented reality device 100. When included in the augmented reality device 100, these inertial motion units can be used as orientation sensors to measure the orientation of one or more of the frame 101 and/or stems 102,103 in three-dimensional space 127. Similarly, the inertial motion units can be used as orientation sensors to measure the motion of one or more of the frame 101 and/or stems 102,103 in three-dimensional space 127. The inertial motion units can be used to make other measurements as well.

In one or more embodiments, the inertial motion unit(s) can be configured as orientation detectors that determine the orientation and/or movement of the augmented reality device 100 in three-dimensional space 127. Illustrating by example, the inertial motion unit can determine the spatial orientation of the augmented reality device 100 in three-dimensional space 127 by, for example, detecting a gravitational direction 128 using an accelerometer. In addition to, or instead of, an accelerometer, magnetometers can be included to detect the spatial orientation of the electronic device relative to the earth's magnetic field. Similarly, one or more gyroscopes can be included to detect rotational orientation of the augmented reality device 100.

Motion of the augmented reality device 100 can similarly be detected. The accelerometers, gyroscopes, and/or magnetometers can be used as a motion detector 114 in the augmented reality device 100. The inertial motion unit(s) can also be used to determine the spatial orientation of the augmented reality device 100 in three-dimensional space 127 by detecting a gravitational direction 128. Similarly, the gyroscopes can be included to detect rotational motion of the augmented reality device 100.

In one or more embodiments, the inertial motion unit(s) determine an orientation of the device housing in which it is situated in three-dimensional space. For example, where only one inertial motion unit is included in the first stem 102, this inertial motion unit is configured to determine an orientation, which can include measurements of azimuth, plumb, tilt, velocity, angular velocity, acceleration, and angular acceleration, of the first stem 102. Similarly, where two inertial motion units are included, with one inertial motion unit being situated in the first stem 102 and another inertial motion unit being situated in the second stem 103, each inertial motion unit determines the orientation of its respective stem. Each inertial motion unit can determine measurements of azimuth, plumb, tilt, velocity, angular velocity, acceleration, angular acceleration, and so forth. In one or more embodiments, each inertial motion unit can determine deviation of the augmented reality device 100 from each axis of the three-dimensional space 127 across time in radians per second.

In one or more embodiments, each inertial motion unit delivers these orientation measurements to the one or more processors 111 in the form of orientation determination signals. Said differently, in one or more embodiments each inertial motion unit outputs an orientation determination signal comprising the determined orientation of its respective device housing.

In one or more embodiments, the augmented reality device 100 includes a companion device display integration manager 124. The companion device display integration manager 124 can be used to communicate with a companion electronic device. Illustrating by example, when another device transmits event notifications, subtitles, or other contextual information to the augmented reality device 100, the companion device display integration manager 124 can deliver that information to the augmented reality image presentation device 121 for presentation to the user as one or more virtual elements in the augmented reality environment via the projector 122.

The augmented reality device 100 of FIG. 1 can operate as a stand-alone electronic device in one or more embodiments. However, in other embodiments, the augmented reality device 100 can operate in tandem with another electronic device, via wireless electronic communication using the wireless communication device 113, or via a wired connection channel 123 to form an augmented reality system.

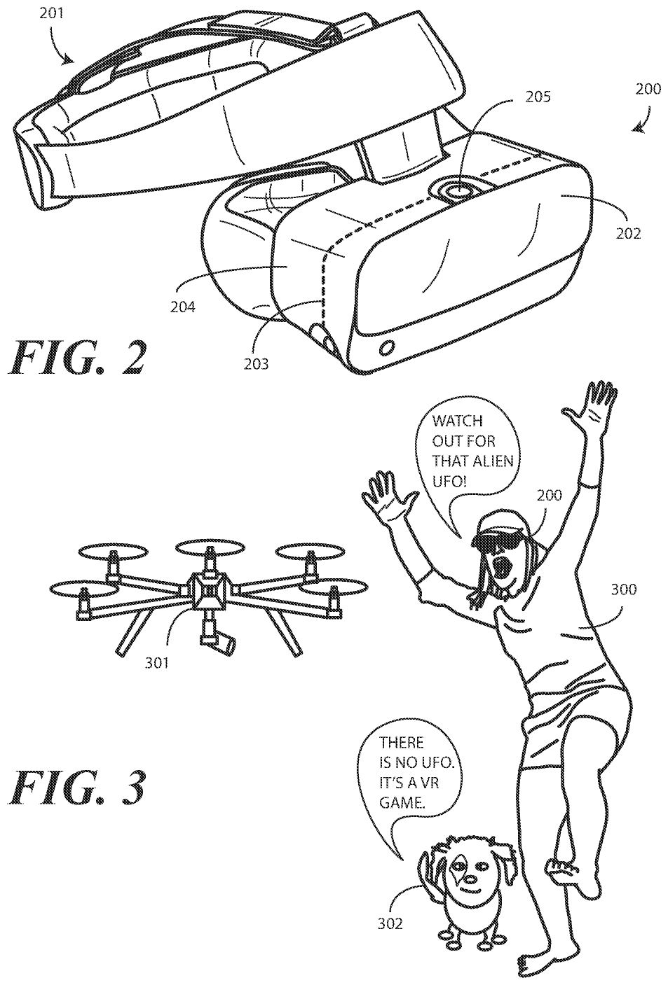

Turning now to FIG. 2, illustrated therein is another electronic device configured in accordance with one or more embodiments of the disclosure. While the electronic device of FIG. 1 was an augmented reality device (100), the electronic device of FIG. 2 is a “virtual” reality device 200. As with the augmented reality device (100) of FIG. 1, the virtual reality device 200 of FIG. 2 is configured as a headwear device that can be worn by a user.

In this illustrative embodiment, the virtual reality device 200 includes a head receiver 201. The head receiver 201 is to receive a user's head. When the user desires to don the virtual reality device 200, they place their head into the head receiver 201. The head receiver 201 can be adjustable to accommodate different sizes of heads. While the head receiver 201 is shown illustratively as a headband and overhead strap combination, it can take other forms as well, including structural shapes such as a cap, hat, helmet, or other head-covering device.

The virtual reality device 200 also includes a shield 202 to block light from entering a virtual reality cabin positioned around the eyes of a wearer. In one or more embodiments, a virtual reality display is positioned behind this shield 202. In one embodiment, the shield 202 is manufactured from an opaque material, such as an opaque thermoplastic material.

In this illustrative embodiment, the shield 202 is coupled directly to the head receiver 201. However, other configurations will be obvious to those of ordinary skill in the art having the benefit of this disclosure. Illustrating by example, the shield 202 can be pivotally coupled to the head receiver 201 such that it can be moved between a first position relative to the head receiver 201 and a second position that is angularly displaced about the head receiver 201 relative to the first position. In still other embodiments, the shield 202 can be coupled to the head receiver 201 by way of a track. Other configurations and coupling schemes will be obvious to those of ordinary skill in the art having the benefit of this disclosure.

In one or more embodiments, a holographic optical element 203 is positioned within the virtual reality cabin positioned around the user's eyes. In one or more embodiments, the holographic optical element 203 is translucent such that ambient light can pass therethrough. The holographic optical element 203 can be any of a lens, filter, beam splitter, diffraction grating, or other device capable of reflecting light received along the interior of the virtual reality cabin to create holographic images. In one illustrative embodiment, the holographic optical element 203 comprises a pellucid holographic lens that is either integral to, or coupled to, the shield 202. Other examples of holographic optical elements will be obvious to those of ordinary skill in the art having the benefit of this disclosure.

Electronic components, many of which were described with reference to the block diagram schematic (125) of FIG. 1, can be integrated into the virtual reality device 200. Accordingly, in such embodiments the virtual reality device 200 can include a display and corresponding electronics or alternatively a pair of displays, e.g., a left display and a right display. The display can optionally include a projector as previously described. Where a single display is used, it can of course present multiple images to the user at the same time (one for each eye). To provide a richer virtual reality experience, different information or content can be delivered to each of the user's eyes.

In one or more embodiments, the virtual reality cabin also includes one or more optical lenses situated therein. In one or more embodiments, the one or more optical lenses can bend light to make it easier for the user's eyes to see. Additionally, where multiple images are presented to the user at the same time, the one or more optical lenses can help segregate this content so that the proper content reaches the proper eye without interference from content intended for the other eye. In one embodiment, the one or more optical lenses comprise Fresnel lenses. In another embodiment, the one or more optical lenses comprise hybrid Fresnel lenses. Other types of lenses will be obvious to those of ordinary skill in the art having the benefit of this disclosure.

In one or more embodiments, a virtual reality cabin perimeter material 204 extends distally from the shield 202 to prevent ambient light from passing to the eyes of a user. This material works to ensure that the minimum quantity of exterior light reaches the user's eyes when operating as a virtual reality headset. The material can also work to improve the user experience by reducing noise introduced by ambient light interfering with the images presented by the display of the virtual reality device 200. Moreover, the display of the virtual reality device 200 can operate at a lower brightness, thereby conserving power when the material is in place. The material can optionally be detachable for cleaning or other operations.

The virtual reality device 200 can optionally include integrated electronics as well. Accordingly, the head receiver 201 or another part of the virtual reality device 200 can comprise one or more electrical components. Some of these electrical components were described above in FIG. 1. It will be clear to those of ordinary skill in the art having the benefit of this disclosure that the electrical components and associated modules can be used in different combinations, with some components and modules included and others omitted. Components or modules can be included or excluded based upon need or application.

The electronic components can include one or more processors (111). The one or more processors (111) can be operable with a memory (112). The one or more processors (111), which may be any of one or more microprocessors, programmable logic, application specific integrated circuit device, or other similar device, are capable of executing program instructions and methods. The program instructions and methods may be stored either on-board in the one or more processors (111), or in the memory (112), or in other computer readable media coupled to the one or more processors (111).

In one or more embodiments, the virtual reality device 200 also includes an optional wireless communication device (113). Where included, the wireless communication device (113) is operable with the one or more processors (111) and is used to facilitate electronic communication with one or more electronic devices or servers or other communication devices across a network. Note that it is possible to combine the one or more processors (111), the memory (112), and the wireless communication device (113) into a single device, or alternatively into devices having fewer parts while retaining the functionality of the constituent parts.

A battery or other energy storage device can be included to provide power for the various components of the virtual reality device 200. Again, it will be obvious to those of ordinary skill in the art having the benefit of this disclosure that other energy storage devices can be used instead of the battery, including a micro fuel cell or an electrochemical capacitor. The battery can include a lithium-ion cell or a nickel metal hydride cell, such cells having sufficient energy capacity, wide operating temperature range, large number of charging cycles, and long useful life. The battery may also include overvoltage and overcurrent protection and charging circuitry. In one embodiment, the battery comprises a small, lithium polymer cell.

Other components (116) can be optionally included in the virtual reality device 200 as well. For example, in one embodiment one or more microphones can be included as audio capture devices. These audio capture devices can be operable with the one or more processors (111) to receive voice input. Additionally, in one or more embodiments the audio capture device can capture ambient audio noise and cancel it out. In one or more embodiments, the audio capture device can record audio to the memory (112) for transmission through the wireless communication device (113) to a server complex across a network.

The other components (116) can also include a motion generation device for providing haptic notifications or vibration notifications to a user. For example, a piezoelectric transducer, rotational motor, or other electromechanical device can be configured to impart a force or vibration upon the head receiver 201. The motion generation device can provide a thump, bump, vibration, or other physical sensation to the user. The one or more processors (111) can be configured to actuate the motion generation device to deliver a tactile or vibration output alone or in combination with other outputs such as audible outputs.

Similarly, in one or more embodiments the eyewear can include a video capture device (129) such as an imager. In one or more embodiments, the video capture device (129) can function as a to detect changes in optical intensity, color, light, or shadow in the near vicinity of the virtual reality device 200. Other optional components include a global positioning system device for determining where the virtual reality device 200 is located. The global positioning system device can communicate with a constellation of earth orbiting satellites or a network of terrestrial base stations to determine an approximate location. While a global positioning system device is one example of a location determination module, it will be clear to those of ordinary skill in the art having the benefit of this disclosure that other location determination devices, such as electronic compasses or gyroscopes, could be used as well.

An optional user interface 205 can be included. The user interface 205 can be used, for example, to activate the circuit components or turn them OFF and so forth. The user interface 205, where included, can be operable with the one or more processors (111) to deliver information to, and receive information from, a user. The user interface 205 can include a rocker switches, slider pad, button, touch-sensitive surface, or other controls, and optionally a voice command interface. These various components can be integrated together.

In one or more embodiments, an audio output device (120), such as a loudspeaker or other transducer, can deliver audio output to a user. For example, piezoelectric transducers can be operably disposed within the head receiver. Actuation of the piezoelectric transducers can cause the same to vibrate, thereby emitting acoustic output. More traditional audio output devices (117), such as loudspeakers, can be used as well.

Sensor circuits of the virtual reality device 200 can also include motion detectors, such as one or more accelerometers, gyroscopes, magnetometers, and/or inertial motion units. For example, an accelerometer may be used to show vertical orientation, constant tilt and/or whether the virtual reality device 200 is stationary. The measurement of tilt relative to gravity is referred to as “static acceleration,” while the measurement of motion and/or vibration is referred to as “dynamic acceleration.” A gyroscope can be used in a similar fashion.

The motion detectors can also be used to determine the spatial orientation of the virtual reality device 200 as well in three-dimensional space by detecting a gravitational direction. In addition to, or instead of, an accelerometer and/or gyroscope, an electronic compass can be included to detect the spatial orientation of the virtual reality device 200 relative to the earth's magnetic field. Similarly, the gyroscope can be included to detect rotational motion of the virtual reality device 200 in three-dimensional space.

The virtual reality device 200 of FIG. 2 can operate as a stand-alone electronic device in one or more embodiments, such as when it includes a display and other corresponding electronic components as noted above. However, in other embodiments, the virtual reality device 200 can operate in tandem with a portable electronic device, such as a smartphone or computer, to form a combined headwear/eyewear system.

The distinction between the augmented reality device (100) of FIG. 1 and the virtual reality device 200 of FIG. 2 is that the virtual reality device 200 of FIG. 2 presents images to a user's eyes solely using components of the virtual reality device 200 and without the addition of light from the physical environment. Illustrating by example, turning now to FIG. 3, a user 300 is wearing the augmented reality device 200 of FIG. 2 and is enjoying a rich virtual reality experience. The user believes that an alien UFO 301 is about to attack her. The experience is so real that she takes a frightened stance and exclaims “watch out for that alien UFO.” However, since the alien UFO 301 is being presented to her only as a virtual reality element, she is the only that sees it. Buster, the dog 302, sees nothing and is confused by her frightened exclamations.

The user would be reminded of this fact if she could see the expression on the dog's face. However, since she is wearing a virtual reality device 200, she cannot see the dog because light from outside the virtual reality device 200 is prevented from passing through the virtual reality device 200 to the user's eyes. Had the user 300 been wearing the augmented reality device (100) of FIG. 1, she still would have seen the alien UFO 301, but would also have been able to see the dog 302. Accordingly, she probably would not have been so engrossed as to lose herself with the scared exclamation due to the fact that she could see the real environment along with the augmented reality environment.

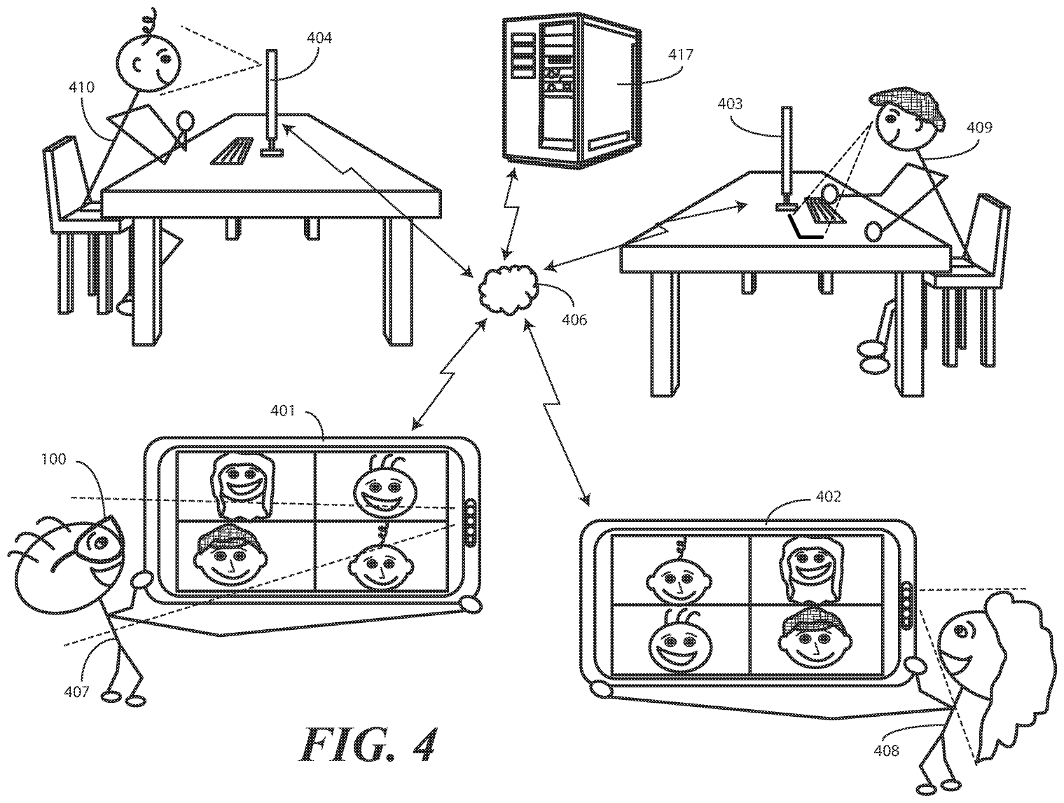

By contrast, turning now to FIG. 4, another user, shown as videoconference participant 407, is wearing the augmented reality device 100 of FIG. 1. The augmented reality device 100 provides a different experience from that provided by the virtual reality device (200), namely, one in which electronically generated images are presented to the user as an augmentation to light or images received from the physical environment. Accordingly, the videoconference participant 407 can see both his videoconference device and virtual element presented in the augmented reality environment.

Since both the virtual reality device (200) of FIG. 2 and the augmented reality device 100 of FIG. 1 can present virtual elements to a user, the methods, devices, and systems described herein for selecting a virtual element in such an environment can be applied to either device. For simplicity, the augmented reality device 100 of FIG. 1 will be used in illustrative examples that follow to illustrate the operation, benefits, and advantages offered by embodiments of the disclosure. Since they can apply to either a virtual reality environment generated by the virtual reality device (200) of FIG. 2 or the augmented reality device 100 of FIG. 1, their environments may be referred to collectively as VR/AR environments, with the devices sometimes being collectively referred to as VR/AR devices.

To illustrate how the embodiments of a VR/AR device function in one or more embodiments, a use case familiar and relatable to anyone who has lived through the SARS-Cov-19 pandemic will be used for illustrative purposes: a videoconference. This explanatory use case is illustrative only and serves to illustrate how a VR/AR device configured in accordance with one or more embodiments of the disclosure can select a virtual element from a VR/AR environment when the VR/AR device is stationary for a predefined duration while a cursor interacts with a virtual element of the VR/AR environment. Other examples and use cases will be readily apparent to those of ordinary skill in the art having the benefit of this disclosure.

In one or more embodiments, a VR/AR device is configured as a VR/AR headset having a display device presenting a VR/AR environment comprising a cursor and one or more embodiments virtual elements to a user. One or more motion detectors determine whether the VR/AR headset is moving or stationary in three-dimensional space. One or more processors, operable with the one or more motion detectors, select a virtual element from a plurality of virtual elements in response to the one or more motion detectors determining the VR/AR headset is stationary in three-dimensional space while the cursor is interacting with the virtual element. The use case introduced in FIG. 4 will explain this operation in more detail. As noted above, numerous other applications, use cases, and examples of how embodiments of the disclosure can be used to select virtual element in a VR/AR environment will be obvious to those of ordinary skill in the art having the benefit of this disclosure.

As shown in FIG. 4, multiple participants 407,408,409,410 are engaged in the all too familiar videoconference. Each participant 407,408,409,410 employs their own respective conferencing system terminal device 401,402,403,404 to engage with the other participants in the videoconference. In this illustrative embodiment, conferencing system terminal devices 401,402 are shown as smartphones, while conferencing system terminal devices 403,404 are shown as desktop computers.

While this system provides one explanatory configuration of electronic devices engaged in a videoconference, conferencing system terminal devices suitable for use in the videoconference system can take other forms as well. For instance, tablet computers, notebook computers, audiovisual devices, mobile phones, smart watches, or other devices can be used by participants to engage in the videoconference as well. Other examples of conferencing system terminal devices will be obvious to those of ordinary skill in the art having the benefit of this disclosure.

As shown in FIG. 4, each conferencing system terminal device 401,402,403,404 is engaged in wired or wireless communication with each other across a network 406, one example of which is the Internet via the World Wide Web. It should be noted that the network 406 could be a public, private, local area, wide area, or other type of network across which wired or wireless electronic communications can be exchanged.

In this illustrative embodiment, each conferencing system terminal device 401,402,403,404 is also in communication with a video conferencing system server complex 417 across the network 406. In one or more embodiments video conferencing system server complex 417 includes components such as a web server, a database server, an audio server, and optionally a video server (the video server may be omitted for audio only conferencing systems) that are operable to facilitate videoconferences between the various conferencing system terminal devices 401,402,403,404 of the videoconference system.

These components of the video conferencing system server complex 417 can be combined on the same server. Alternatively, these components can be distributed on any number of servers to increase load handling capacity beyond that of a single server, and so forth. Other configurations for the video conferencing system server complex 417 will be obvious to those of ordinary skill in the art having the benefit of this disclosure.

In one or more embodiments, the video conferencing system server complex 417 performs functions such as maintaining a schedule of videoconferences, maintaining lists of participants, as well as allowing each participant's conferencing system terminal device to engage with the videoconference, and so forth. In one or more embodiments, the video conferencing system server complex 417 also facilitates the transmission of audio and video content during the occurrence of the videoconference.

In one or more embodiments, the video conferencing system server complex 417 functions as an intermediary device to facilitate sharing of audio and/or video content and/or data between the various conferencing system terminal devices 401,402,403,404. For example, as can be seen on the displays of conferencing system terminal device 402, in this example participant 408 can see each other participant engaged in the videoconference.

Since the participants 407,408,409,410 are all engaged in a videoconference, each can see conference content in the form of a combined video feed from each other participant 407,408,409,410 presented on the display of each conferencing system terminal device 401,402,403,404, as well as a video feed of themselves. Under ordinary conditions, each participant 407,408,409,410 can hear an audio feed from each other participant 407,408,409,410 as well.

As shown in FIG. 4, participant 407 is using an augmented reality device 100 configured as a pair of augmented reality glasses. The augmented reality device 100 provides a field of view in which an augmented reality environment is presented. In one or more embodiments, the augmented reality environment can function as an auxiliary display for his conferencing system terminal device 401.

In this illustrative embodiment, the conferencing system terminal device 401 belonging to participant 407 is electronically in communication with the augmented reality device 100. When the conferencing system terminal device 401 is electronically in communication with the augmented reality device 100, this allows the conferencing system terminal device 401 to cause the presentation of augmented reality imagery, including one or more embodiments virtual elements, within an augmented reality environment presented within a field of view of the augmented reality device 100.

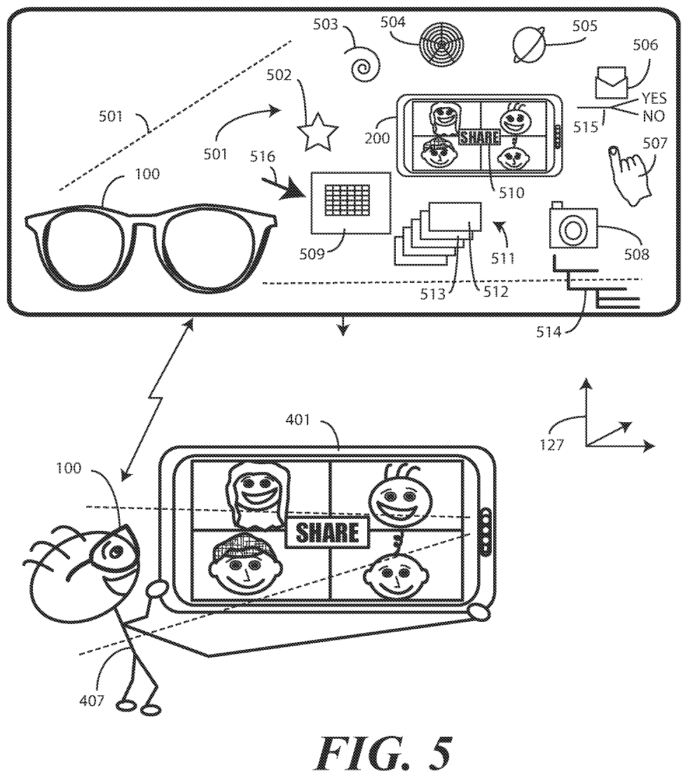

In the illustrative example of FIG. 4, participant 407 wants to become the presenter. Participant 407 also desires to share content with the other conferencing system terminal devices 402,403,404. To do this, participant 407 must select an application and file. Participant 407 must then inform the conferencing system terminal device 401 that the selected file should be shared with the other participants 408,409,410. Since the augmented reality device 100 is configured in accordance with embodiments of the disclosure, participant 407 can make this selection in a “hands free” manner. Turning now to FIG. 5 illustrated therein are one or more method steps showing the initial steps of how participant 407 might do this.

As shown, the one or more processors (111) of the augmented reality device 100 present, in a field of view 501 of the augmented reality device 100, a virtual reality environment 500. Within the virtual reality environment 500 are presented a plurality of virtual elements 502,503,504,505,506,507,508,509. Each virtual element 502,503,504,505,506,507,508,509 represents an application, widget, button, control, or other user actuation target participant 407 may select to launch corresponding applications, control hardware, and/or explore other portions of the virtual reality environment 500.

In one or more embodiments, each virtual element 502,503,504,505,506,507,508,509 represents one or more content offerings available to be shared with the one or more remote electronic devices engaged in the videoconference. This plurality of content offerings can comprise one or more of an application actively operating on the one or more processors of the conferencing system terminal device 401, a tab of a web browser, an image of a display of the conferencing system terminal device 401 operating during the videoconference, a file manager, or an application window. Other examples of potential content offerings suitable for inclusion with the content verification presentation will be obvious to those of ordinary skill in the art having the benefit of this disclosure.

As shown, since many applications operate on conferencing system terminal device 401, the number of virtual elements is large. Additionally, the presentation is fairly closely packed in a carousel presentation around the conferencing system terminal device 401, with each virtual element placed relatively close to its neighbor. While this would make the selection of a particular virtual element a challenging process when using prior art systems, embodiments of the disclosure make the process really simple.

Before proceeding with explaining how the participant 407 will select a virtual element and corresponding file to be shared in the videoconference, it should be noted that the various virtual elements 502,503,504,505,506,507,508,509 can take various forms/Illustrating by example, virtual element 503 is a link to a specific file and is therefore a singular virtual element. Selection and actuation of it launches a file directly. By contrast, virtual element 509 identifies an application suite 511 within the augmented reality environment 500. Accordingly, selection and actuation of this virtual element 509 causes a plurality of sub-virtual elements, e.g., sub-virtual elements 512,513 to appear thereafter. Selection of virtual element 508 causes a menu tree 514 to be presented, while selection and actuation of virtual element 506 causes a decision tree 515 to be presented. These explanatory examples are set forth merely to show that the virtual elements 502,503,504,505,506,507,508,509 presented in a VR/AR environment can take various forms, and that selection and actuation of some can cause a plurality of sub-virtual elements to be presented thereafter. These examples are illustrative only, as numerous other virtual elements will be obvious to those of ordinary skill in the art having the benefit of this disclosure.

As shown in FIG. 5, the carousel presentation defines a ring at least partially encircling the view of the conferencing system terminal device 401, as seen through the augmented reality device 100. In one or more embodiments, the carousel presentation causes the augmented reality images defining each virtual element to encircle the view of the conferencing system terminal device 401. However, other configurations for the carousel presentation can occur as well. Illustrating by example, the carousel presentation could cause the augmented reality images defining each virtual element to define a square about the view of the conferencing system terminal device 401. Alternatively, the carousel presentation may be omitted, with the augmented reality images defining each virtual element being presented above, to the side, or below the view of the conferencing system terminal device 401.

In addition to the virtual elements 502,503,504,505,506,507,508,509 positioned around the conferencing system terminal device 401 in the carousel presentation, another virtual element 510 is presented atop the conferencing system terminal device 401. This virtual element 510 is associated with the videoconference program operating on the conferencing system terminal device 401 and allows content to be shared with other participants when participant 407 is acting as the presenter. Additionally, in one or more embodiments when the augmented reality device 100 is presenting the augmented reality environment 500 with its display device, a cursor 516 is presented as well. In one or more embodiments, one or more motion sensors of the augmented reality device 100 detect movement of the augmented reality device 100 in three-dimensional space 127. One or more processors of the augmented reality device 100 then move the cursor 516 within the augmented reality device 500 as a function of the movement.

As an initial step, participant 407 needs to inform the videoconference application operating on the conferencing system terminal device 401 that he intends to share content. To do this, participant 407 must select virtual element 510 to indicate that content will be shared from the conferencing system terminal device 401 with the other conferencing system terminal devices engaged in the videoconference. Thereafter, participant 407 must select both the application via which the content is presented and the content itself. Participant 407 does this by moving his head, and thus the augmented reality device 100, in three-dimensional space 127. The one or more motion sensors of the augmented reality device 100 detect this movement of the augmented reality device 100 in three-dimensional space 127 and move the cursor 516 in the augmented reality environment 500 as a function of the movement. Thus, participant 407 moves his head until the cursor 516 overlaps virtual element 510 as an initial step.

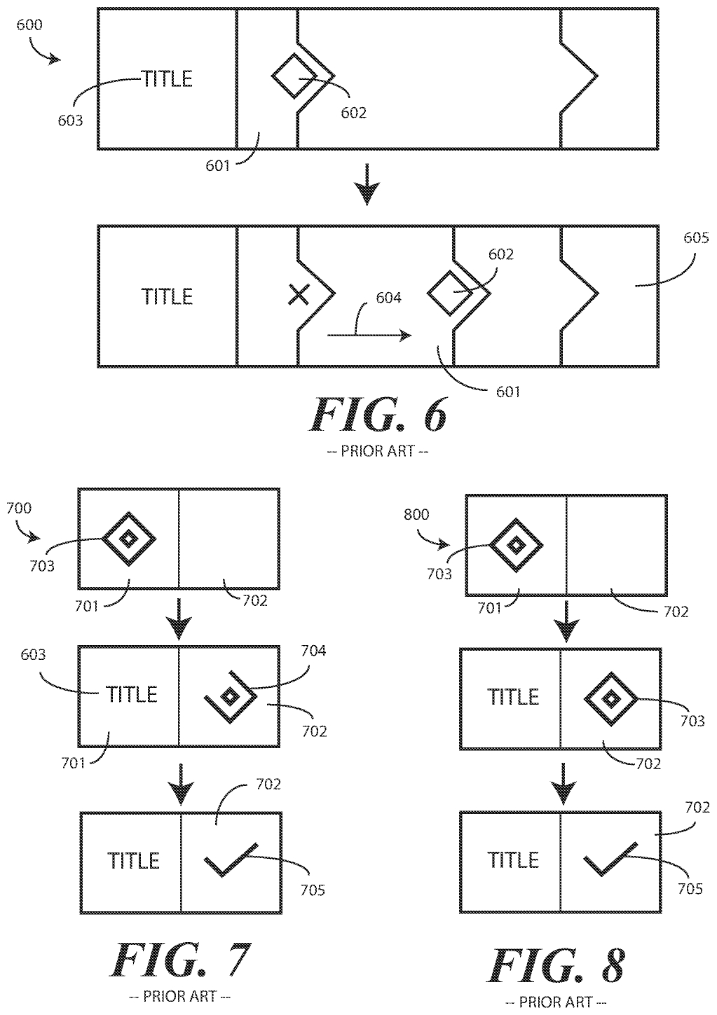

Prior to further discussing how embodiments of the disclosure make the selection of virtual element 510 simple and error free, a brief illustration of how prior art systems would make the selection is in order. Examples of three such prior art techniques are shown in FIGS. 6-8. Each is initiated when the cursor 516 initially interacts with virtual element 510.

Turning first to FIG. 6, illustrated therein is a “two-step inline” process. After the cursor (516) interacts with virtual element (510), a slider mechanism 600 appears adjacent to the virtual element (510). The slider mechanism 600 includes a slider 601 that can be manipulated by a user using the cursor (516). To actuate the virtual element (510), a user first reads a description 603 of the virtual element (510) presented in the slider mechanism 600 to ensure that the virtual element (510) selected was indeed the one desired. Thereafter, the user must navigate the cursor (516) to a slider control 602 positioned within the slider 601 and hover there to select the slider control 602. The user must then drag 604 the slider control 602 and corresponding slider 601 to the right to a slider ender 605. Only after the slider 601 connects with the slider ender 605 will the virtual element (510) be actuated. As one might imagine, this selection process is tedious and complex, and requires multiple movements, multiple wait states, and dexterous manipulation of the slider 601. Basically, it's a hard process.

Turning now to FIG. 7, illustrated therein is the aforementioned gaze and dwell method. The gaze and dwell method is a technique that requires to distinct and separate control operations to successfully function. After the cursor (516) interacts with virtual element (510), a timer mechanism 700 appears adjacent to the virtual element (510). The timer mechanism 700 includes a start window 701 and a completion window 702. When the timer mechanism 700 appears, an initiation icon 703 is presented in the start window 701. The initiation icon 703 alerts a user to the fact that the gaze and dwell method has been initiated.

Thereafter, the initiation icon 703 moves to the completion window 702 and starts to decompose in accordance with the expiration of a timer. The initiation icon 703 appearing as a decomposing icon 704 with more and more parts of the decomposing icon 704 disappearing as the timer counts down. Additionally, a description 603 of the virtual element (510) appears in the start window 701. If the user wants to ensure that the virtual element (510) was indeed the one intended, they'd better read fast because the timer is counting down. Once the timer expires, the decomposing icon 704 changes into a selection icon 705 presented in the completion window. This means that the virtual element (510) has been selected.

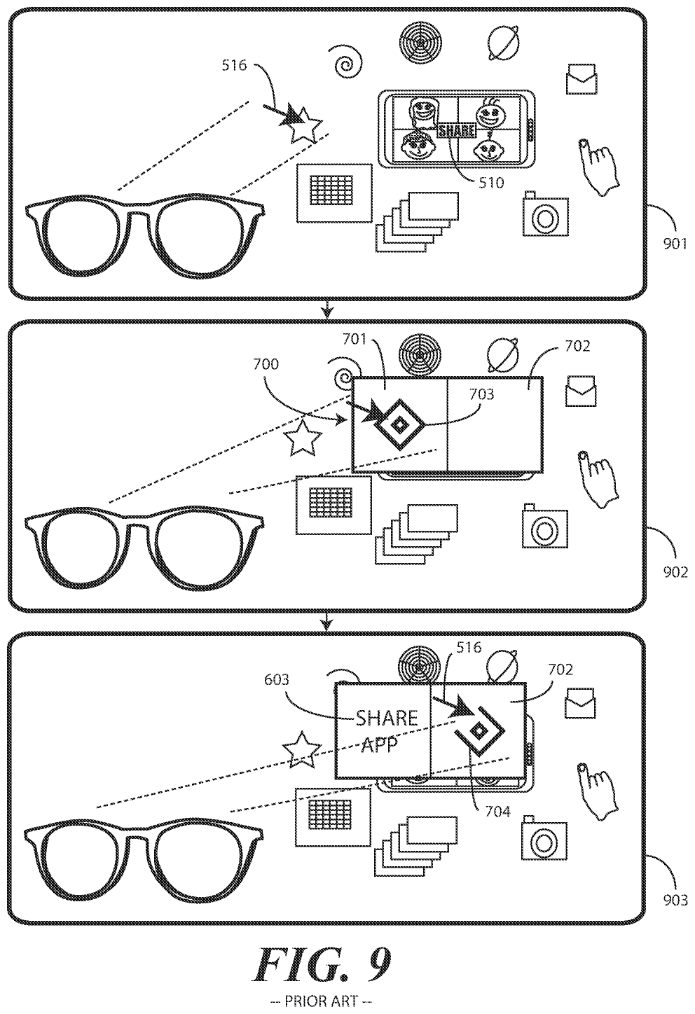

To show how the gaze and dwell method works in greater detail, turn now to FIG. 9. Beginning at step 901, in the “gaze” portion the user must move the cursor 516 within the augmented reality environment using motion of the user's head. Once the cursor 516 sufficiently interacts with the virtual element 510, the “dwell” portion begins.

In the “dwell” portion of the method, after cursor 516 is first aligned with the virtual element 510, a “door” then appears alongside the virtual element 510. This “door” is shown at step 902 as a timer mechanism 700 appearing atop the virtual element 510. As previously described, the timer mechanism 700 includes a start window 701 and a completion window 702. When the timer mechanism 700 appears, an initiation icon 703 is presented in the start window 701. The initiation icon 703 alerts a user to the fact that the gaze and dwell method has been initiated.

When the cursor 516 hovers or “dwells” at the “door,” the initiation icon 703 moves to the completion window 702. Decomposition of the initiation icon 703 occurs in accordance with the expiration of a timer, as shown at step 903.

The initiation icon 703 then appears as a decomposing icon 704 with more and more parts of the decomposing icon 704 disappearing as the timer counts down. Additionally, a description 603 of the virtual element 510 appears in the start window 701. If the user wants to ensure that the virtual element 510 was indeed the one intended, they had better read pretty darned fast because the timer is counting down.

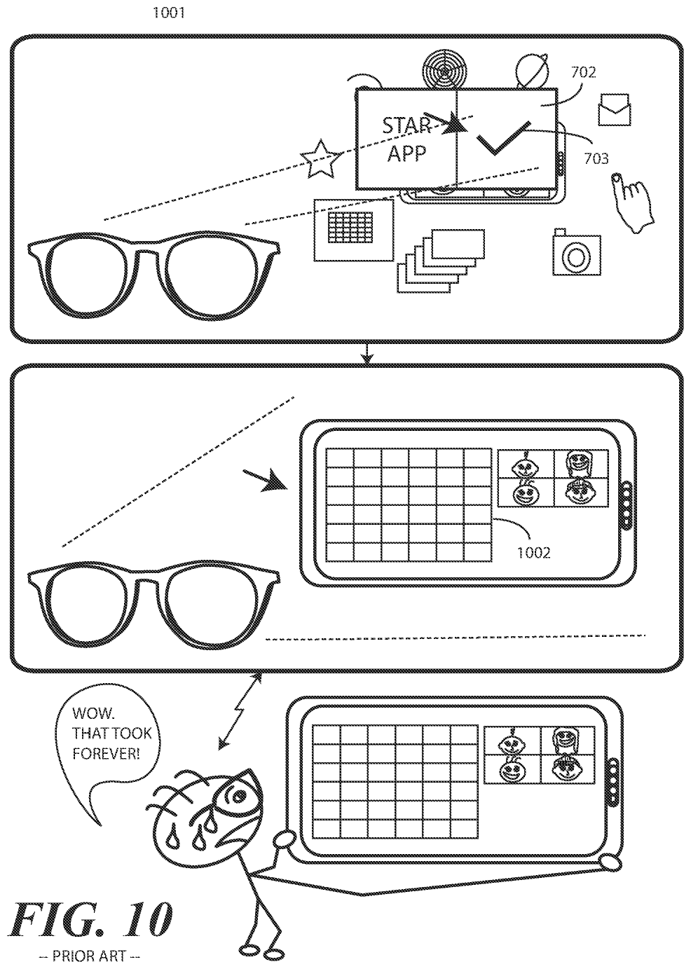

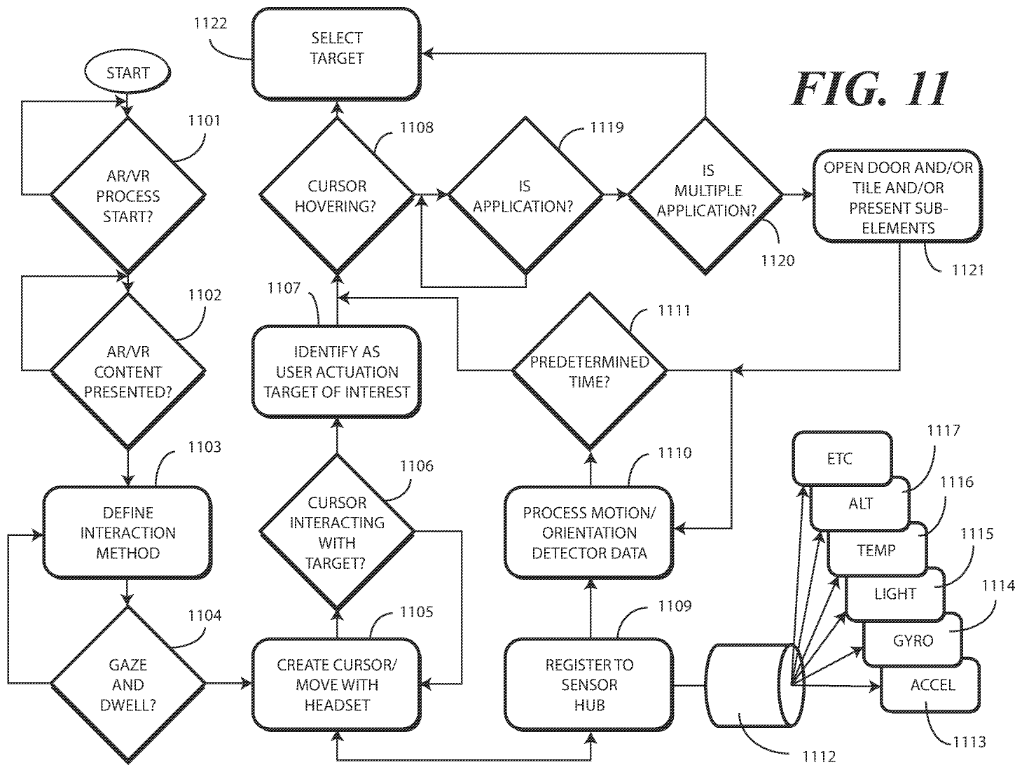

Turning now to FIG. 10, as shown at step 1001 the decomposing icon (704) changes into a selection icon 705 presented in the completion window once the timer expires. This means that the virtual element (510) has been selected. This initiates a sharing application. The poor user, flustered and flabbergasted at the incredibly large number of steps and lengthy amount of time that was required just to indicate that content was to be shared, must now make the journey all over again to select not only the application, but also the content 1002 to be shared. With other participants waiting for this process to occur and growing ever more and more frustrated, a user may question why they ever even bothered to purchase a prior art augmented reality headset that used the gaze and dwell method.

This frustration is painfully palpable because the gaze and dwell method illustrated in FIGS. 9 and 10 is a timer-based process requiring both navigation steps, e.g., to select a virtual element to cause the door to appear and wait steps where the timer countdown occurs as the animation of the door proceeds. In effect, the result of these multiple processes is that once the cursor is made to hover over the virtual element, a timer is initiated. When the timer expires, the virtual element initially selected is actuated.

The problem with gaze and dwell is that false selection of virtual elements frequently occurs. Since virtual elements are typically packed quite closely together in a VR/AR environment, it is frequently the case when a user is looking at a particular virtual element (perhaps to read an identifier or otherwise figure out what the virtual element does) an accidental selection will occur causing a door to appear. Moreover, when a virtual element represents a bundle of sub-virtual elements that open when the virtual element is initially selected, this accidental selection can further clutter the VR/AR environment, thereby making selection of a desired virtual element even more difficult.

To compound matters, gaze and dwell is prone to misuse. In the development cycle of virtual reality or augmented reality applications, new software code is frequently added. When not properly vetted, this new code can include security vulnerabilities that can be exploited by rogue or spy software code that may perform a malicious task that is harmful to the VR/AR device user.

Turning now back to FIG. 8, illustrated therein is one additional prior art method of selecting a virtual element in an VR/AR environment. The method of FIG. 8 is known as the “two-step trigger” method. The two-step trigger method is like the gaze and dwell but includes another step of moving the cursor (516) to the door. The difference between the two-step dwell and the two-step trigger is that two-step dwell is timer based, with actuation occurring with the expiration of a timer, while actuation of the two-step trigger occurs once the cursor (516) interacts with the door.

After the cursor (516) interacts with virtual element (510), a selection mechanism 800 appears adjacent to the virtual element (510). The selection mechanism 800 includes a start window 701 and a completion window 702. When the selection mechanism 800 appears, an initiation icon 703 is presented in the start window 701.

Thereafter, the user must move the cursor (516) to interact with the selection mechanism 800 and move the initiation icon 703 to the completion window 702. When this occurs, a description 603 of the virtual element (510) appears in the start window 701. If the user wants to ensure that the virtual element (510) was indeed the one intended, better read amazingly fast because the virtual element (510) will be actuated as soon as the initiation icon 703 hits the completion window 702. Once moved, the initiation icon 703 changes into a selection icon 705 presented in the completion window. This means that the virtual element (510) has been selected.

Embodiments of the disclosure provide a new and improved method of selecting a virtual element in a VR/AR environment that provides solutions to the problems associated with the prior art methods of FIGS. 6-8 by both eliminating the time-based selection component of the dwell portion of the gaze and dwell method and by reducing the number of overall steps required to actuate a virtual element found in the two-step inline and two-step trigger methods. Rather than using a timer countdown or multi-step process, embodiments of the disclosure take advantage of the on-board motion detectors found in either the augmented reality device (100) of FIG. 1 or the virtual reality device (200) of FIG. 2. In one or more embodiments, one or more processors sample one or more motion detectors incorporated in a VR/AR device to determine whether the VR/AR device is moving or stationary in three-dimensional space when a cursor is interacting with a virtual element.

In one or more embodiments motion, as detected by the one or more motion detectors, is used to move the cursor in the VR/AR environment. Embodiments of the disclosure then leverage these motion detectors to determine when the VR/AR device is stationary when the cursor interacts with a particular virtual element, thereby allowing for the elimination of any timer countdown requirement in a virtual element selection process.

In one or more embodiments, when a cursor interacts with a virtual element, such as when a portion of the cursor hovers within a perimeter defined by the virtual element, one or more processors of the VR/AR device monitor and/or sample data from the one or more motion detectors. When the user's head, and thus the VR/AR device, is determined to be stable, the one or more processors sample the data from the one or more motion detectors to determine whether the VR/AR device is stationary for at least a predefined duration in three-dimensional space while the cursor interacts with the virtual element. In one or more embodiments, when this occurs, the one or more processors select and/or actuate the virtual element with which the cursor is interacting. If the virtual element happens to be a virtual element with multiple sub-virtual elements “underneath” it, another set of sub-virtual elements can be presented when the primary virtual element is selected and actuated.

Advantageously, embodiments of the disclosure eliminate the false or accidental selection of virtual element in an VR/AR environment that frequently occurs when the gaze and dwell method, or other method, is used. Illustrating by example, using the prior art system of gaze and dwell, a user has a limited amount of time defined by the countdown timer of the door within which they can interact with a virtual element before it is actuated. If they are trying to read a description or other content associated with the virtual element, reading must be expedient because the timer is running. By contrast, using embodiments of the disclosure where actuation is based upon VR/AR device stability, a user can interact with a virtual element for an indefinite amount of time without actuation, instead actuating the virtual element only when the user is certain that the desired virtual element is the one with which the cursor is interacting.

In one or more embodiments, a method of selecting a virtual element in a VR/AR environment generated by a VR/AR device includes detecting, with one or more processors, a cursor interacting with the virtual element. In one or more embodiments, the method includes determining, with one or more sensors, whether the VR/AR device is stationary for at least a predefined duration while the cursor interacts with the virtual element. In one or more embodiments, the one or more processors select the virtual element when the VR/AR device is stationary for the predefined duration with the cursor interacting with the virtual element.

In another embodiment, a method of selecting a virtual element in a VR/AR environment generated by a VR/AR headset includes presenting, with a display device, the VR/AR environment. When one or more motion sensors detect movement of the VR/AR headset in three-dimensional space, one or more processors of the VR/AR headset move a cursor within the VR/AR environment as a function of the movement of the VR/AR headset in the three-dimensional space.

In this alternate method, rather than measuring time the determination of whether the VR/AR device is stationary includes obtaining at least a predefined number of movement measurement samples that have sufficiently consistent measurement readings to determine whether the stationary state has been maintained for a sufficient duration. In one or more embodiments, the one or more processors thus obtain from the one or more sensors in response to the cursor interacting with the virtual element a predefined number of movement measurement samples. The one or more processors actuate the virtual element in the VR/AR environment when a variation of the predefined number of movement measurement samples is less than a predefined variation threshold.

In effect, embodiments of the disclosure eliminate the time-based and/or multi-step manipulation of the cursor to make actuation of a virtual element in a VR/AR environment seamless by sampling motion sensor data. In one or more embodiments, when the cursor sits on a virtual element, one or more processors of the VR/AR device monitor the motion sensor data. When the head is stable and without movement, the motion sensors are sampled while the cursor drift is constant. Where this stable drift continues for a predefined duration threshold, such as one second, the virtual element is actuated.

Turning now to FIG. 11, illustrated therein is a flow chart illustrating one explanatory method in accordance with one or more embodiments of the disclosure. Decision 1101 first determines whether an VR/AR process has been initiated in a VR/AR device. Decision 1102 determines whether a VR/AR environment is being presented with one or more virtual elements appearing therein. Once a display device of the VR/AR device presents the VR/AR environment and the various virtual elements, the process moves to step 1103.

At step 1103, the interaction method of selecting and actuating virtual elements within the VR/AR environment is defined. In one or more embodiments, this process that is defined at step 1103 comprises obtaining, in response to the cursor interacting with a virtual element, a predefined number of movement measurement samples and actuating the virtual element in the VR/AR environment when a variation of the predefined number of movement measurement samples is less than a predefined variation threshold. In another embodiment, this process comprises determining whether the VR/AR device is stationary for at least a predefined duration while the cursor interacts with the virtual element and selecting the virtual element when the VR/AR device is stationary for the predefined duration while the cursor interacts with the virtual element. Decision 1104 determines when this definition is complete.

With the desired interaction method now defined, the process moves to step 1105 where a cursor is created within the VR/AR environment. In one or more embodiments, step 1105 further comprises detecting, with one or more motion detectors or motion sensors, movement of the VR/AR device in three-dimensional space and moving, by one or more embodiments of the VR/AR device, the cursor within the VR/AR environment as a function of the movement.

Decision 1106 detects whether the cursor is interacting with a particular virtual element. In one or more embodiments, decision 1106 comprised determining whether a portion of the cursor is hovering within a perimeter defined by the virtual element. Where it is, step 1107 identifies the virtual element with which the cursor is interacting as a virtual element of interest.

While this is occurring, another process runs in parallel. Specifically, once the cursor is created at step 1105, at step 1109 cursor movement is registered with a sensor hub 1112 receiving signals from one or more sensors. These sensors can include one or more motion sensors, such as accelerometer 1113 and/or gyroscope 1114. However, the sensors operable with the sensor hub 1112 can include other sensors as well, examples of which include a light sensor 1115, a temperature sensor 1116, an altimeter 1117, or other sensors.

Step 1110 samples the sensor data received at the sensor hub 1112 to determine whether motion of the cursor, as defined by motion of the VR/AR device, is stationary. This can be done by either determining that a predefined number of movement measurement samples have a variation less than a predefined variation threshold. Alternatively, it can be done by determining that the VR/AR device is stationary within three-dimensional space for at least a predefined duration.

The variation between the predefined number of movement measurement samples and/or the predefined duration when time is used can vary based upon application, desired sensitivity, or other factors. Embodiments of the disclosure contemplate that with most motion detectors, a reasonable benchmark for stability is when the one or more motion detectors determine the VR/AR device is stationary when the VR/AR device moves less than 1/1000^{th} radians from each dimension (x,y,z) of three-dimensional space during a predefined duration of 1000 milliseconds (or less). Said differently, when motion detector or motion sensor readings are almost zero, e.g., to three decimal places when the readings are in radians per second, this provides sufficient evidence to actuate the virtual element.

While motion detectors or motion sensors making such measurements can have readings as high as four radians per second when head movement is significant, experimental testing indicates that when the head is reasonably still there is little movement in the decimal readings, with at least three decimal readings being zero. Accordingly, this amount of stability and predefined duration provide one example of values suitable for use in practice. However, it should be noted that these values are illustrative only. It will be obvious to those of ordinary skill in the art having the benefit of this disclosure that other values, including larger or smaller movement thresholds and/or longer or shorter predefined durations can be selected based upon a desired application, motion detector, motion sensor, or other factors. Accordingly, embodiments of the disclosure are not limited by these explanatory thresholds unless positively recited in the claims below.

Decision 1111 determines whether the VR/AR device is stationary. As noted above, this can be done by determining whether the VR/AR device is stationary for a predefined duration in one embodiment. In another embodiment, this can comprise determining whether a variation of a predefined number of movement measurement samples is less than a predefined variation threshold.

In one or more embodiments, decision 1111 comprises detecting, from a gyroscope measuring radians per second of movement of the VR/AR device in three dimensions, the radians per second of movement being less than a predefined movement threshold in each dimension of the three dimensions for the predefined duration. In one or more embodiments, the predefined movement threshold is 1/1000^{th} radians per second. In the illustrative embodiment of FIG. 11, the determination of whether the VR/AR device is stationary for at least the predefined duration while the cursor interacts with the virtual element determined at decision 1108 occurs in response to detecting the cursor interacting with the virtual element at decision 1106.

Regardless, of which method is used, decision 1108 determines whether the VR/AR device is sufficiently stationary while the cursor interacts with the virtual element. Where it is, step 1122 selects and actuates the virtual element. As illustrated in FIG. 11, this process precludes any selection of the virtual element when the cursor interacts with the virtual element and the sensors operable with the sensor hub 1112 indicate the VR/AR device is moving in three-dimensional space due to the fact that this particular actuation technique was defined at step 1103.

As noted above, some virtual elements can represent applications. Others can represent suites of applications. Decision 1119 determines the former, while decision 1120 determines the latter. If the former, step 1122 selects and actuates the virtual element, thereby launching the application or bringing the application to the forefront in the VR/AR environment.

By contrast, when the virtual element represents a suite of applications, step 1121 can comprise presenting one or more sub-elements as described above with reference to FIG. 5. This can occur when the virtual element represents a multiplicity of applications within the VR/AR environment. Actuation of the virtual element can reveal many other virtual elements representing the various applications identified by the initial virtual element.

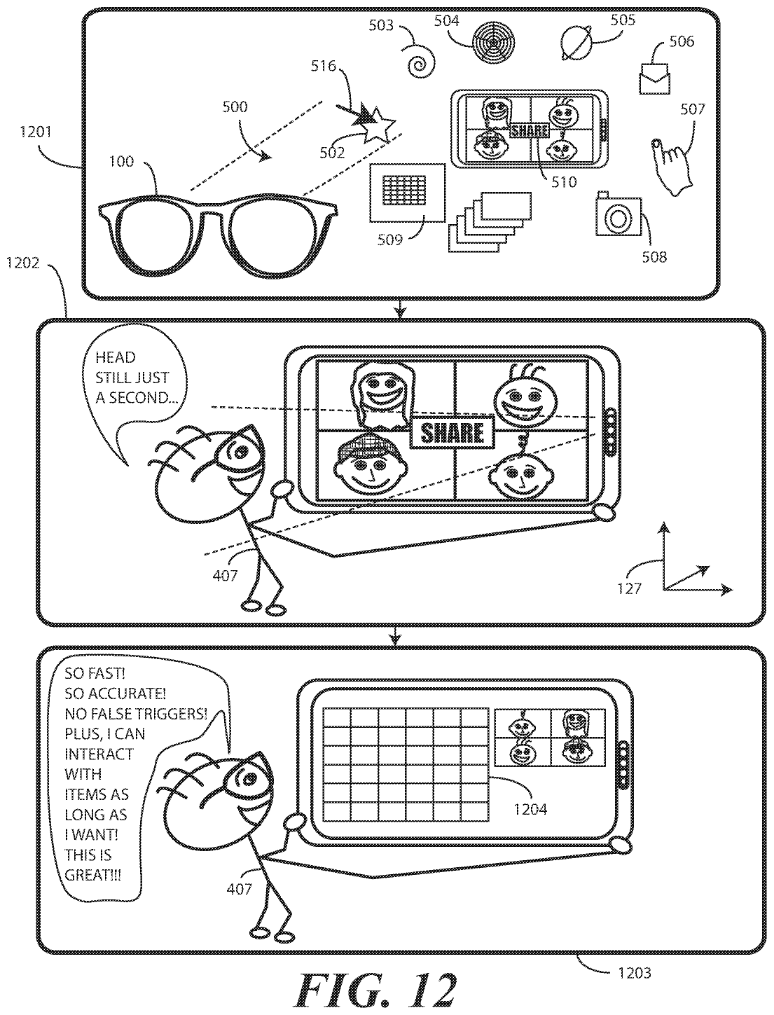

A summary of this method can be seen in FIG. 12. Turning now to FIG. 12, participant 407—continuing the example begun in FIG. 5—has already used the method of FIG. 11 to move the augmented reality device 100, and therefore the cursor 516, to virtual element 510 to alert the videoconference application operating in the conferencing system terminal device 401 that he intends to share content. To illustrate how simple this was, participant 407 now needs to select content. Accordingly, at step 1201 he moves the cursor 516 to virtual element 502, which represents a file stored on a shared server. The augmented reality device 100 is configured as a VR/AR headset with a display device presenting the VR/AR environment 500 comprising the cursor 516 and the one or more virtual elements 502,503,504,505,506,507,508,509.

At step 1202, participant 407 holds his head still for one second. One or more motion detectors (114) of the augmented reality device 100 determine whether the VR/AR headset is moving or stationary in three-dimensional space 127. In one or more embodiments, this comprises obtaining a predetermined number of movement measurement readings from the one or more motion detectors (114) and confirming that a difference variation between all movement measurement readings of the predetermined number of movement measurement readings is below a predefined variation threshold, one example of which is less than 1/1000th radians from each dimension of the three-dimensional space. In other embodiments, this comprises determining whether the VR/AR headset is stationary for the at least a predefined duration while the cursor 516 interacts with the virtual element 502 occurs in response to the detecting the cursor 516 interacting with the virtual element 502, one example of which is 1000 milliseconds.

Since this occurs, one or more processors (111) of the augmented reality device 100 select virtual element 502 at step 1202 in response to the one or more motion detectors determining the VR/AR headset is stationary in the three-dimensional space 127 while the cursor 516 interacts with the virtual element 502.

As shown at step 1203, this launches the content 1204 to be shared in a faction of the time, and with far less steps and less error, than any of the prior art methods described above with reference to FIGS. 5-8. In one or more embodiments, the one or more processors (111) of the augmented reality device 100 the one or more processors select and actuate the virtual element 502 only in response to the one or more motion detectors (114) determining the augmented reality device is stationary in the three-dimensional space 127 while the cursor 516 is interacting with the virtual element 502 for a predefined duration. Participant 407 is pleasantly surprised and pleased at how seamless, quick, and simple the process was, as are the other participants of the videoconference.

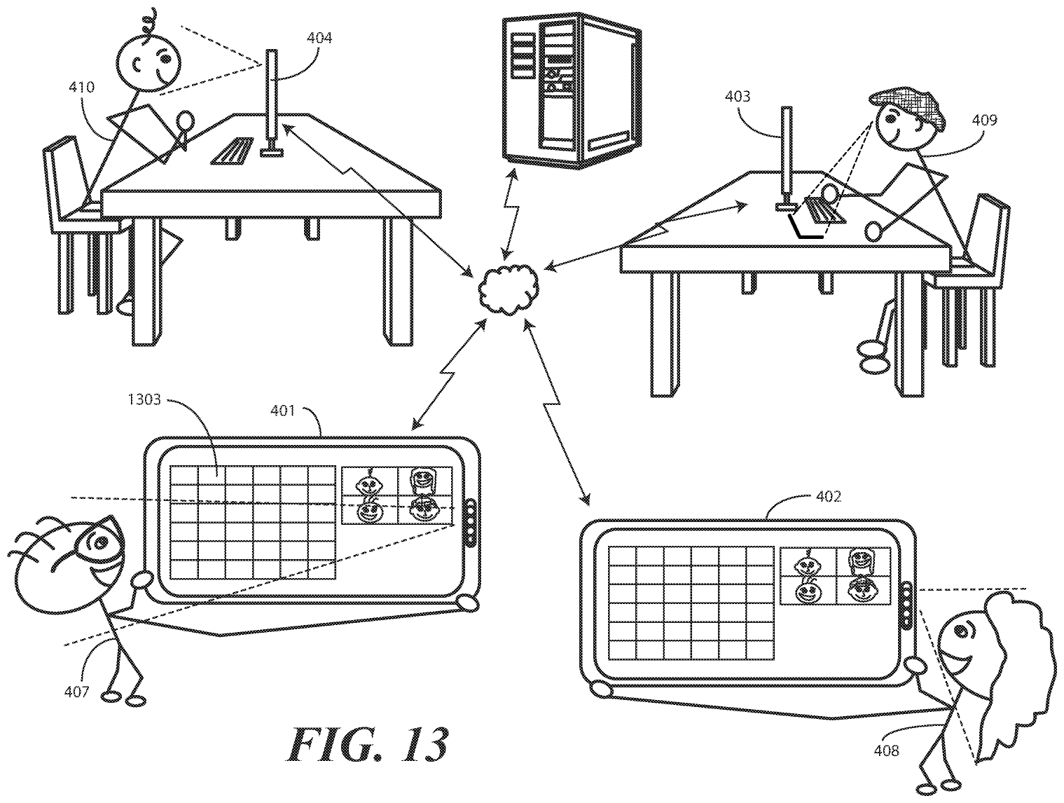

Turning now to FIG. 13, illustrated therein are the results of the methods of FIGS. 11-12. Participant 407 has selected a spreadsheet 1303 as the content to be shared. This causes the spreadsheet 1303 to be shared with the other conferencing system terminal devices 402,403,404. As shown in FIG. 13, this results in the spreadsheet 1303 being moved to the shared space of the videoconference. As shown on the display of conferencing system terminal device 402, this means the spreadsheet 1303 is successfully being shown to other participants 408,409,410 in the shared space of the videoconference.

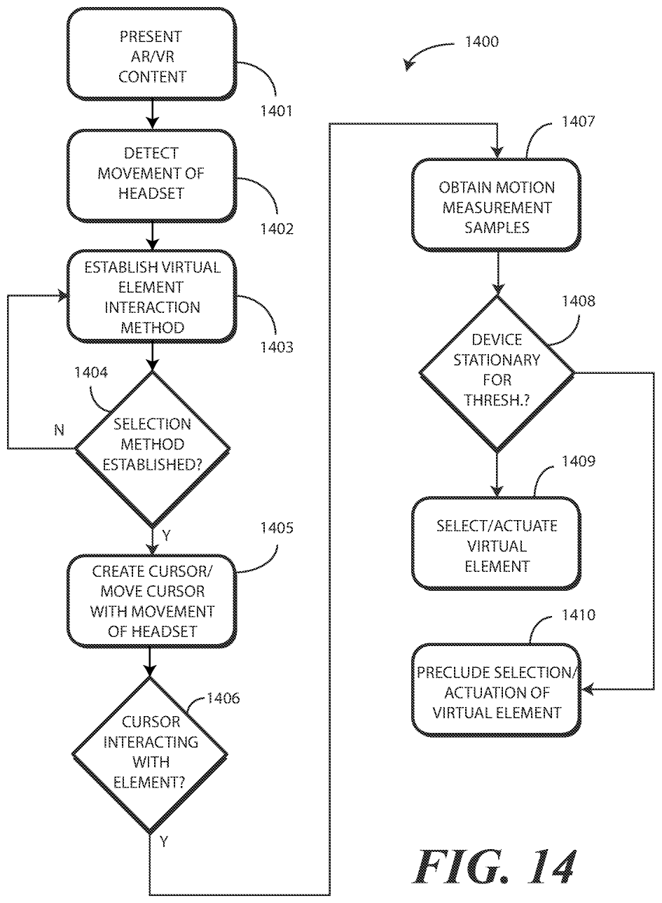

Turning now to FIG. 14, illustrated therein is one additional method 1400 in accordance with one or more embodiments of the disclosure. At step 1401 a display device of a VR/AR headset presents a VR/AR environment. In one or more embodiments, the VR/AR environment presented at step 1401 includes a plurality of virtual elements. At step 1402, the method 1400 detects, with one or more motion sensors, movement of the VR/AR headset in three-dimensional space.

Step 1403 establishes a virtual element interaction method. In one or more embodiments, the method comprises obtaining, from one or more motion sensors, a predefined number of movement measurement samples and actuating a virtual element when the variation of the predefined number of movement measurement samples is less than a predefined variation threshold while a cursor interacts with a virtual element. In another embodiment, step 1403 comprises determining, with one or more motion sensors, whether the VR/AR headset is stationary for a predefined duration while a cursor interacts with a virtual element. Decision 1404 confirms that the definition of step 1403 is complete.

Step 1405 creates a cursor within the VR/AR environment. In one or more embodiments, step 1405 also comprises moving a cursor presented in the VR/AR environment as a function of movement of the VR/AR environment in the three-dimensional space detected at step 1402.

Step 1406 determines whether the cursor is interacting with a virtual element. Where it is, step 1407 obtains a predefined number of movement measurement samples from one or more motion sensors in one or more embodiments. In other embodiments, step 1406 determines how long the VR/AR headset is stationary as a function of time.

Decision 1408 actuates the virtual element when the VR/AR headset is sufficiently stable while the cursor interacts with the virtual element. In one or more embodiments, decision 1408 determines whether a variation of the predefined number of movement measurement samples is less than a predefined variation threshold while the cursor is interacting with the virtual element. In another embodiment, decision 1408 determines whether the VR/AR headset is stable for at least a predefined duration threshold while the cursor interacts with the virtual element. Where the condition is met, step 1409 actuates the virtual element. Otherwise, step 1410 precludes the actuation of the virtual element. Illustrating by example, in one or more embodiments step 1410 precludes the selection and/or actuation of the virtual element when the cursor interacts with the virtual element and the one or more sensors indicate the VR/AR headset is moving in three-dimensional space.

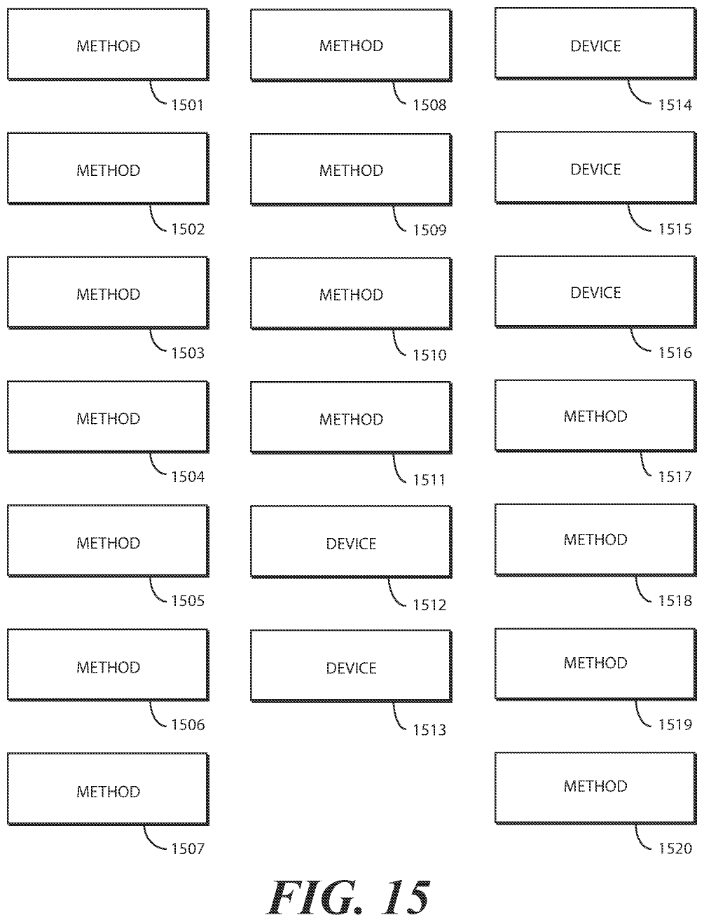

Turning now to FIG. 15, illustrated therein are various embodiments of the disclosure. The embodiments of FIG. 15 are shown as labeled boxes in FIG. 15 due to the fact that the individual components of these embodiments have been illustrated in detail in FIGS. 1-14, which precede FIG. 15. Accordingly, since these items have previously been illustrated and described, their repeated illustration is no longer essential for a proper understanding of these embodiments. Thus, the embodiments are shown as labeled boxes.

At 1501, a method of selecting a virtual element in a VR/AR environment generated by a VR/AR device comprises detecting, with one or more processors, a cursor interacting with the virtual element. At 1501, the method comprises determining, with one or more sensors, whether the VR/AR device is stationary for at least a predefined duration while the cursor interacts with the virtual element. At 1501, the method comprises selecting, with the one or more processors, the virtual element when the VR/AR device is stationary for the predefined duration with the cursor interacting with the virtual element.

At 1502, the cursor of 1501 interacts with the virtual element by hovering a portion of the cursor within a perimeter defined by the virtual element. At 1503, the method of 1501 further comprises detecting, with the one or more sensors, movement of the VR/AR device in three-dimensional space and moving, by one or more processors of the VR/AR device, the cursor within the VR/AR environment as a function of the movement of the VR/AR device in the three-dimensional space.

At 1504, the predefined duration of 1501 is one thousand milliseconds or less. At 1505, the one or more sensors of 1501 comprise a gyroscope measuring radians per second of movement of the VR/AR device in three dimensions.

At 1506, the determining whether the VR/AR device of 1505 is stationary comprises detecting the radians per second of movement being less than a predefined movement threshold in each dimension of the three dimensions for the predefined duration. At 1507, the predefined movement threshold of 1506 is 1/1000th radians per second.

At 1508, the selection of the virtual element of 1501 comprises presenting one or more sub-elements when the virtual element represents a multiplicity of applications of the VR/AR environment. At 1509, the determination of whether the VR/AR device of 1501 is stationary for the at least a predefined duration while the cursor interacts with the virtual element occurs in response to the detecting the cursor interacting with the virtual element.

At 1510, the determination of whether the VR/AR device of 1501 is stationary comprises obtaining a predetermined number of movement measurement readings from the one or more sensors and confirming that a difference variation between all movement measurement readings of the predetermined number of movement measurement readings is below a predefined variation threshold. At 1511, the method of 1501 further comprises precluding selection of the virtual element while the cursor interacts with the virtual element and the one or more sensors indicate the VR/AR device is moving in three-dimensional space.

At 1512, a VR/AR headset comprises a display device presenting a VR/AR environment comprising a cursor and one or more virtual elements. At 1512, the VR/AR headset comprises one or more motion detectors determining whether the VR/AR headset is moving or stationary in three-dimensional space.

At 1512, the VR/AR headset comprises one or more processors that are operable with the one or more motion detectors. At 1512, the one or more processors select a virtual element of the one or more virtual elements in response to the one or more motion detectors determining the VR/AR headset is stationary in the three-dimensional space while the cursor is interacting with the virtual element.

At 1513, the one or more processors of 1512 select the virtual element only in response to the one or more motion detectors determining the VR/AR device is stationary in the three-dimensional space while the cursor is interacting with the virtual element for a predefined duration. At 1514, the one or more motion detectors of 1513 comprise one or more of a gyroscope, an accelerometer, and/or an inertial measurement unit.

At 1515, the one or more motion detectors of 1514 determine the VR/AR headset is stationary when the VR/AR headset moves less than 1/1000th radians from each dimension of the three-dimensional space during the predefined duration. At 1516, the selecting of 1514 comprises the one or more processors presenting a plurality of virtual elements when the virtual element identifies an application suite within the VR/AR environment.

At 1517, a method of selecting a virtual element in a VR/AR environment generated by a VR/AR headset comprises presenting, with a display device, the VR/AR environment. At 1517, the method comprises detecting, with one or more motion sensors, movement of the VR/AR headset in three-dimensional space and moving, with one or more processors, a cursor within the VR/AR environment as a function of the movement.

At 1517, the method comprises obtaining, by the one or more processors from the one or more motion sensors in response to the cursor interacting with the virtual element, a predefined number of movement measurement samples. At 1517, the method comprises actuating the virtual element in the VR/AR environment when a variation of the predefined number of movement measurement samples is less than a predefined variation threshold.

At 1518, the actuating of 1517 comprises presenting a plurality of virtual sub-elements identified by the virtual element. At 1519, the method of 1517 further comprises presenting the cursor in response to the one or more motion sensors defining a virtual element selection process. At 1520, the variation of 1519 is less than 1/1000th of a radian.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A method of selecting a virtual element in a virtual reality or augmented reality (VR/AR) environment generated by a VR/AR device, the method comprising:
detecting, with one or more processors, a cursor interacting with the virtual element;
determining, with one or more sensors, whether the VR/AR device is stationary for at least a predefined duration while the cursor interacts with the virtual element by determining that readings of a motion sensor are zero radians per second to at least three decimal places, in three dimensions, for the predefined duration; and
selecting, with the one or more processors, the virtual element when the VR/AR device is stationary for the predefined duration with the cursor interacting with the virtual element.

2. The method of claim 1, wherein the determining whether the VR/AR device is stationary for at least the predefined duration while the cursor interacts with the virtual element comprising determining that the readings of the motion sensor are zero radians per second to at least four decimal places.

3. The method of claim 1, further comprising:
creating the cursor; and
in a parallel process to creating the cursor, registering cursor movement with a sensor hub receiving signals from the one or more sensors.

4. The method of claim 1, wherein the predefined duration is one thousand milliseconds or less.

5. The method of claim 3, wherein the one or more sensors comprise a gyroscope measuring radians per second of movement of the VR/AR device in three dimensions, a light sensor, a temperature sensor, and an altimeter.

6. The method of claim 5, wherein the selecting the virtual element when the VR/AR device is stationary for the predefined duration with the cursor interacting with the virtual element causes a decision tree to appear and the determining whether the VR/AR device is stationary comprises detecting the radians per second of movement being less than a predefined movement threshold in each dimension of the three dimensions for the predefined duration.

7. The method of claim 6, wherein the predefined movement threshold is 1/1000^{th} radians per second.

8. The method of claim 1, wherein the selecting the virtual element causes one or more sub-elements to be presented and arranged in a menu tree when the virtual element represents a multiplicity of applications of the VR/AR environment.

9. The method of claim 1, wherein interaction of the cursor with the virtual element can occur for an indefinite amount of time without actuation of the virtual element.

10. The method of claim 1, wherein the virtual element is one of a plurality of virtual elements, with each virtual element representing one or more content offerings available to be shared with one or more remote electronic devices engaged in a videoconference.

11. The method of claim 1, wherein the virtual element is one of a plurality of virtual elements presented in a home screen during an onboarding process, wherein the plurality of virtual elements represent:
applications;
widgets;
buttons;
controls; and
other user actuation targets operable to:
control hardware; and
explore other portions of the VR/AR environment generated by a VR/AR device.

12. A VR/AR headset, comprising:
a display device presenting a VR/AR environment comprising a cursor and one or more virtual elements;
one or more motion detectors determining whether the VR/AR headset is moving or stationary in three-dimensional space; and
one or more processors, operable with the one or more motion detectors, the one or more processors selecting a virtual element of the one or more virtual elements in response to the one or more motion detectors determining the VR/AR headset is stationary in the three-dimensional space while the cursor is interacting with the virtual element;
the one or more motion detectors determining the VR/AR headset is stationary when the VR/AR headset moves less than 1/1000th radians from each dimension of the three-dimensional space during a predefined duration.

13. The VR/AR headset of claim 12, wherein:
the VR/AR headset comprises an AR headset comprising a frame and two stems extending distally from the frame; and
the one or more motion detectors consist of a single inertial motion unit situated in the frame.

14. The VR/AR headset of claim 12, wherein:
the VR/AR headset comprises an AR headset comprising a frame and a first stem and a second stem extending distally from the frame; and
the one or more motion detectors consist of three inertial motion units, with a first motion situated in the frame, a second inertial motion unit situated in the first stem and a third inertial motion unit situated in the second stem.

15. The VR/AR headset of claim 12, wherein:
the one or more virtual elements consist of a single virtual element presented atop a content presentation companion device situated within an environment of the VR/AR headset; and
actuation of the single virtual element presented atop the content presentation companion device causes one or more other virtual elements to be presented in a non-overlapping arrangement around the content presentation companion device.

16. The VR/AR headset of claim 15, wherein the one or more other virtual elements comprise a plurality of virtual elements arranged in a ring or square around the content presentation companion device.

17. A method of selecting a virtual element in a virtual reality or augmented reality (VR/AR) environment generated by a VR/AR headset, the method comprising:
presenting, with a display device, the VR/AR environment;
detecting, with one or more motion sensors, movement of the VR/AR headset in three-dimensional space and moving, with one or more processors, a cursor within the VR/AR environment as a function of the movement;
obtaining, by the one or more processors from the one or more motion sensors in response to the cursor interacting with the virtual element, a predefined number of movement measurement samples; and
actuating the virtual element in the VR/AR environment when a variation of radians per second measurements in the predefined number of movement measurement samples is zero to three decimal places for each dimension of three dimensional space for at least 1000 milliseconds.

18. The method of claim 17, wherein the actuating the virtual element comprises presenting a plurality of virtual sub-elements identified by the virtual element in a ring around a content presentation companion device situated within an environment of the VR/AR headset.

19. The method of claim 17, wherein the predefined number of movement measurement cycles varies among virtual elements and is selected as a function of an application the virtual element launches.

20. The method of claim 19, wherein the variation is less than 1/1000^{th} of a radian.
